(19) United States
(12) Patent Application Publication
(10) Pub. No.: US 2015/0154029 A1
(43) Pub. Date: Jun. 4, 2015

(54) ELECTRONIC APPARATUS AND OPERATIONAL METHOD THEREOF

(71) Applicants: INVENTEC CORPORATION, Taipei City (TW); INVENTEC (PUDONG) TECHNOLOGY CORPORATION, Shanghai (CN)

(72) Inventor: YING-CHIH LU, Taipei City (TW)

(73) Assignees: INVENTEC CORPORATION, Taipei City (TW); INVENTEC (PUDONG) TECHNOLOGY CORPORATION, Shanghai (CN)

(21) Appl. No.: 14/228,042

(22) Filed: Mar. 27, 2014

(30) Foreign Application Priority Data
Nov. 29, 2013 (CN) 201310631665.8

(51) Int. Cl. G06F 9/44

(52) U.S. Cl. CPC G06F 9/4403

(57) ABSTRACT

The disclosure provides an electronic apparatus and an operation method thereof, wherein the electronic apparatus includes a memory, a baseboard management controller (BMC), a processor, and a controller. During a power-on self test, the controller initializes the memory, sets parameters of a shared space in the memory, disables the shared space, and generates an initialization command according to which the BMC obtains a size of the shared space and establishes an initialization setting for the shared space. Then, the controller generates a loading command according to which the BMC stores an executable file in the shared space through the controller, and the controller enables the shared space and generates a first storing signal according to which the processor runs the executable file to generate an execution completion signal. According to the execution completion signal, the controller disables the shared space and the processor ends the power-on self test.

### CROSS-REFERENCE TO RELATED APPLICATIONS

This non-provisional application claims priority under 35 U.S.C. §119(a) on Patent Application No(s). 201310631665.8 filed in China on Nov. 29, 2013, the entire contents of which are hereby incorporated by reference.

### TECHNICAL FIELD

This disclosure relates to an electronic apparatus and an operational method thereof, and more particularly to an electronic apparatus and an operational method thereof with a heavy load of data transmission.

### BACKGROUND

Generally, a computer system may include a host and a baseboard management controller (BMC). The host and the BMC may need to exchange a heavy load of data, and the heavy load of data is usually transmitted through low pin count (LPC), universal serial bus (USB), or inter-integrated circuit (I2C). However, the transmission rates of LPC and I2C are too slow, and USB is not able to coexist with SMI handler.

Furthermore, though the MBC can define a virtual storage space through USB, the virtual storage space can be accessible under the operating system, thereby making the data exchanged between the host and the BMC unsecured.

### SUMMARY

The present disclosure provides an electronic apparatus according to one or more embodiments. In one embodiment, the electronic apparatus comprises a memory, a baseboard management controller, a processor, and a controller. The memory may store a basic input/output system and comprise a shared space. The processor may execute the basic input/output system for a power-on self test. The controller, coupled with the memory, the baseboard management controller, and the processor, may initialize the memory, set a plurality of parameters for the shared space in the memory, disable the shared space, and generate an initialization command during the power-on self test. According to the initialization command, the baseboard management controller may obtain a size of the shared space and establish an initialization setting for a random access memory and a file system in the shared space during the power-on self test. Subsequently, the controller may generate a loading command during the power-on self test. According to the loading command, the baseboard management controller stores an executable file in the shared space through the controller during the power-on self test. Then, during the power-on self test, the controller may enable the shared space and generate a first storing signal according to which the processor runs the executable file to generate an execution completion signal. According to the execution completion signal, the controller may disable the shared space, and the processor may end the power-on self test.

According to one embodiment, when the controller receives a first firmware update signal, the controller may enable the shared space and delete files in the shared space according to a control signal outputted from the baseboard management controller, to store first update firmware corresponding to the first firmware update signal in the shared space, disable the shared space, and generate a second storing signal for the baseboard management controller so that the baseboard management controller may update its firmware with the first update firmware according to the second storing signal.

According to one embodiment, when the controller receives a command sending signal, the controller may enable the shared space and delete files in the shared space according to a control signal outputted from the baseboard management controller, to store a command file corresponding to the command sending signal in the shared space and send out a third storing signal to the baseboard management controller. The baseboard management controller may execute the command file according to the third storing signal to generate an execution result. Then, the controller may store the execution result in the shared space and disable the shared space.

According to one embodiment, when the baseboard management controller receives an interrupt command replacement signal, the baseboard management controller may store an executable replacement file corresponding to the interrupt command replacement signal in the shared space via the controller, and generate an interrupt command and a control signal for the controller so that the controller may generate a fourth storing signal for the processor and enable the shared space. The processor may then execute the executable replacement file to generate an execution completion signal according to the fourth storing signal, and the controller may disable the shared space according to the execution completion signal.

According to one embodiment, when the baseboard management controller receives a second firmware update signal, the baseboard management controller may store second update firmware corresponding to the second firmware update signal in the shared space through the controller, and generate a storing completion signal and a control signal for the controller so that the controller may enable the shared space and generate a fifth storing signal for the processor. The processor may execute the second update firmware according to the fifth storing signal to update the basic input/output system and generate an update completion signal. Then, the controller may disable the shared space according to the update completion signal.

The present disclosure also provides an operation method of an electronic apparatus according to one or more embodiments. In one embodiment, the operation method may comprise the following steps: via a processor, executing a power-on self test for a basic input/output system; via a controller, initializing a memory to define a shared space in the memory, set a plurality of parameters for the shared space, and disable the shared space; via the controller, generating an initialization command for a baseboard management controller; via the baseboard management controller, obtaining a size of the shared space and establishing an initialization setting for a random access memory and a file system in the shared space according to the initialization command; via the controller, generating a loading command for the baseboard management controller; via the baseboard management controller, controlling a controller to store an executable file in the shared space according to the loading command; via the controller, generating a first storing signal and enabling the shared space; via the processor, running the executable file to generate an execution completion signal according to the first storing signal; and according to the execution completion signal, disabling the shared space via the controller and ending the power-on self test via the processor.

According to one embodiment, the operation method may further comprise the following steps: determining whether the controller receives a first firmware update signal; when the controller does not receive the first firmware update signal, repeating the step of determining whether the controller receives the first firmware update signal; when the controller receives the first firmware update signal, determining whether the controller receives a control signal from the baseboard management controller; when the controller receives the control signal, enabling the shared space and deleting files in the shared space to store first update firmware corresponding to the first firmware update signal in the shared space, disable the shared space, and generate a second storing signal for the baseboard management controller via the controller; and via the baseboard management controller, updating firmware of the baseboard management controller with the first update firmware according to the second storing signal.

According to one embodiment, the operation method may further comprise the following steps: determining whether the controller receives a command sending signal; when the controller does not receive the command sending signal, repeating the step of determining whether the controller receives the command sending signal; when the controller receives the command sending signal, determining whether the controller receives a control signal from the baseboard management controller; when the controller receives the controller signal, enabling the shared space and deleting files in the shared space to store a command file corresponding to the command sending signal in the shared space and send out a third storing signal to the baseboard management controller via the controller; via the baseboard management controller, executing the command file to generate an execution result and transmit the execution result to the controller; and via the controller, storing the execution result in the shared space and disabling the shared space.

According to one embodiment, the operation method may further comprise the following steps: determining whether the baseboard management controller receives an interrupt command replacement signal; when the baseboard management controller does not receive the interrupt command replacement signal, repeating the step of determining whether the baseboard management controller receives the interrupt command replacement signal; when the baseboard management controller receives the interrupt command replacement signal, via the baseboard management controller, controlling the controller to store an executable replacement file corresponding to the interrupt command replacement signal in the shared space, and generating an interrupt command and a control signal for the controller; via the controller, generating a fourth storing signal for the processor and enabling the shared space; via the processor, executing the executable replacement file to generate an execution completion signal according to the fourth storing signal; and via the controller, disabling the shared space according to the execution completion signal.

According to one embodiment, the operation method may further comprise the following steps: determining whether the baseboard management controller receives a second firmware update signal; when the baseboard management controller does not receive the second firmware update signal, repeating the step of determining whether the baseboard management controller receives the second firmware update signal; when the baseboard management controller receives the second firmware update signal, via the baseboard management controller, controlling the controller to store a second update firmware corresponding to the second firmware update signal in the shared space, and generating a storing completion signal and a control signal for the controller; via the controller, enabling the shared space and generating a fifth storing signal for the processor; via the processor, executing the second update firmware according to the fifth storing signal to update the basic input/output system, and then generating an update completion signal; and via the controller, disabling the shared space according to the update completion signal.

As set forth above, the disclosure states that, with a shared space defined in the memory, the baseboard management controller and the processor can exchange data, such as executable files, update firmware, command files, or executable replacement files, through this shared space. Moreover, the controller may determine whether to enable or disable the shared space, according to the control signal sent from the baseboard management controller. Therefore, the disclosure may have higher security and efficiency on a heavy load of data exchange or data transmission.

### BRIEF DESCRIPTION OF THE DRAWINGS

The disclosure will become more fully understood from the detailed description given herein below for illustration only, and thus are not limitative of the disclosure, and wherein:

FIG. 1 is a diagram of an electronic apparatus in the disclosure;

FIG. 2 is a flow chart of an operation method of an electronic apparatus in the disclosure;

FIG. 3 is a flow chart of a first embodiment following the step S290 in FIG. 2;

FIG. 4 is a flow chart of a second embodiment following the step S290 in FIG. 2;

FIG. 5 is a flow chart of a third embodiment following the step S290 in FIG. 2; and

FIG. 6 is a flow chart of a fourth embodiment following the step S290 in FIG. 2.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

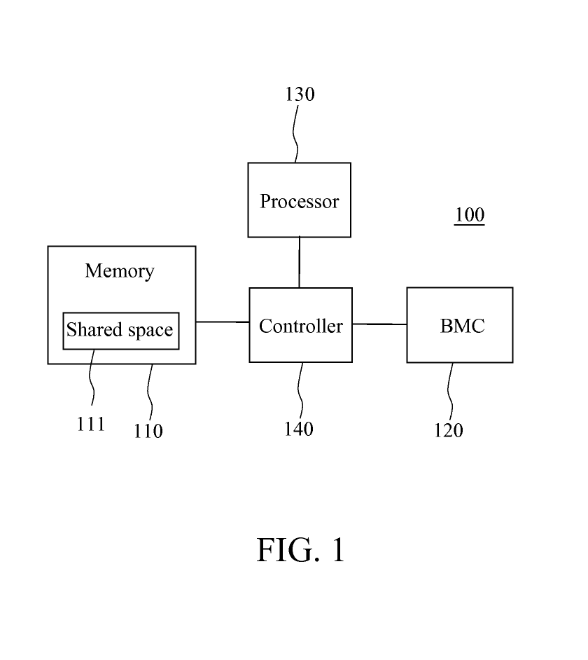

Referring to FIG. 1, FIG. 1 is a diagram of an electronic apparatus in an embodiment in the disclosure. The electronic apparatus 100 of the embodiment, such as a computer system, comprises a memory 110, a baseboard management controller (BMC) 120, a processor 130, and a controller 140. The memory 110 comprises a shared space 111, which is configured to store specific data.

The processor 130, such as a central processing unit (CPU), may execute a basic input/output system (BIOS) to perform a power-on self test (POST).

The controller 140 is coupled with the memory 110, the baseboard management controller 120, and the processor 130. The controller 140 may initialize the memory 110 and set a plurality of parameters for the shared space in the memory 110 during the power-on self test. The parameters are, for example, the base address of the shared space 111, the storage size of the shared space 111, or a combination thereof. For example, the base address is “E000 0000”, and the storage size is 16 MB.

When the controller 140 finishes initializing the memory 110, the controller 140 disables the shared space 111, meaning that the processor 130 is not allowed to access any data in the shared space 111. In one exemplary embodiment, the controller 140 may adjust a flag to enable or disable the shared space 111. For example, if the flag is set as “1”, then the controller 140 enables the shared space 111; and if the flag is set as “0”, then the controller 140 disables the shared space 111. In order to clearly describe the disclosure, the flag of “1” and the flag of “0” are respectively taken as an example to indicate the enabling of the shared space 111 and the disabling of the shared space 111 hereinafter.

Furthermore, when the controller 140 finishes initializing the memory 110, the controller 140 also generates an initialized original equipment manufacturer intelligent platform management interface (OEM IPMI) command to inform the baseboard management controller 120 about the size of the shared space and establish the initialization settings, such as the RAM disk and other file systems, for the shared space 111. Then, the controller 140 generates a loaded OEM IPMI command to inform the baseboard management controller 120 that the executable file is ready and also copies the executable file to the shared space 111. When the baseboard management controller 120 receives the loading command, the baseboard management controller 120 stores the executable file in the shared space 111 through the controller 140. The executable file is, for example, an unified extensible firmware interface driver (UEFI Driver), an UEFI application, an UEFI diagnostic tool, or a service management tool.

After the executable file described above is stored in the shared space 111, the controller 140 generates a first storing signal for the processor 130, and adjusts the flag to “1” to enable the shared space 111. Then, according to the first storing signal, the processor 130 executes the executable file, and generates an execution completion signal after the execution of the executable file is completed. According to the execution completion signal, the controller 140 adjusts the flag to “0” to disable the shared space 111, and the processor 130 also ends the power-on self test. Therefore, through the shared space 111, the baseboard management controller 120 and the processor 130 may exchange a heavy load of data to increase the efficiency of data transmission of the electronic apparatus 100.

After the processor 130 ends the power-on self test, in one embodiment, the controller 140 determines whether a first firmware update signal is received or not. The first firmware update signal may be configured to notify the baseboard management controller 120 of the firmware update. When the controller 140 determines that the first firmware update signal is not received, the controller 140 may continue to determine whether the first firmware update signal is received, until the first firmware update signal is truly received. When the controller 140 determines that the firmware update signal is received, the controller 140 may further determine whether a control signal is received from the baseboard management controller 120. For example, the control signal specifies whether the controller 140 has to enable the shared space 111. When the controller 140 determines that the control signal is not received, the controller 140 continues to determine whether the control signal is received from the baseboard management controller 120, until the control signal is received. When the controller 140 determines that the control signal is received, the controller 140 adjusts the flag to “1” to enable the shared space 111 and deletes the files (i.e. all previous files) in the shared space 111, and the controller 140 stores the first update firmware corresponding to the firmware update signal in the shared space 111. Subsequently, the controller 140 adjusts the flag to “0” to disable the shared space 111, and generates a second storing signal for the baseboard management controller 120. The baseboard management controller 120 updates the firmware inside according to the second storing signal.

After the processor 130 ends the power-on self test, in one embodiment, the controller 140 determines whether a command sending signal is received. For example, the command sending signal specifies whether the baseboard management controller 120 has to execute a heavy load of commands. When the controller 140 determines that the command sending signal is not received, the controller 140 continues to determine whether the command sending signal is received or not, until the command sending signal is truly received. When the controller 140 determines that the command sending signal is received, the controller 140 then further determines whether a control signal from the baseboard management controller 120 is received. For example, the control signal specifies whether the controller 140 has to enable the shared space 111. When the controller 140 determines that the control signal is not received, the controller 140 continues to determine whether the control signal is received or not, until the control signal is truly received. When the controller 140 determines that the control signal described above is received, the controller 140 adjusts the flag to “1” to enable the shared space 111, and deletes the files (i.e. all previous files) in the shared space 111. Then, the controller 140 stores a command file corresponding to the command sending signal in the shared space 111 and sends out a third storing signal to the baseboard management controller 120. The command file may include numerous intelligent platform management interface (IPMI) commands.

Then, the baseboard management controller 120 executes the command file described above according to the third storing signal, and generates an execution result to the controller 140 after the execution of the command file is completed. The controller 140 stores the execution result in the shared space 111 and adjusts the flag to “0” to disable the shared space 111.

After the processor 130 ends the power-on self test, in one embodiment, the baseboard management controller 120 determines whether an interrupt command replacement signal is received. The interrupt command replacement signal may be generated by a remote device and specify which sub interruption commands the processor 140 has to replace. When the baseboard management controller 120 determines that the interrupt command replacement signal is not received, the baseboard management controller 120 continues to determine whether the interrupt command replacement signal is received, until the interrupt command replacement signal is truly received. When the baseboard management controller 120 determines that the interrupt command replacement signal is received, the baseboard management controller 120 stores an executable replacement file corresponding to the interrupt command replacement signal in the shared space 111 through the controller 140, and generates an interrupt command and a control signal for the controller 140. The controller 140 generates a fourth storing signal, e.g. a system management interrupt (SMI), corresponding to the interrupt command, sends the fourth storing signal to the processor 130, and adjusts the flag to “1” to enable the shared space 111 according to the control signal. Then, according to the fourth storing signal, the processor 130 executes an interrupt program, e.g. a SMI processing program, to execute the executable replacement file to replace the specified interrupt commands and generate an execution completion signal after the execution of the executable replacement file is completed. Subsequently, the controller 140 adjusts the flag to “0” to disable the shared space 111 according to the execution completion signal.

After the processor 130 ends the power-on self test, in one embodiment, the baseboard management controller 120 determines whether a second firmware update signal is received. The second firmware update signal may be generated by a remote device and specify that the processor 130 has to update the firmware of the basic input/output system. When the baseboard management controller 120 determines that the second firmware update signal is not received, the baseboard management controller 120 continues to determine whether the second firmware update signal is received or not, until the second firmware update signal is truly received. When the baseboard management controller 120 determines that the second firmware update signal is received, the baseboard management controller 120 stores the second update firmware corresponding to the second firmware update signal in the shared space 111 through the controller 140 and generates a storing completion signal and a control signal for the controller 140. The controller 140 generates a fifth storing signal for the processor 130 according to the storing completion signal, and adjusts the flag to “1” to enable the shared space 111 according to the control signal. Then, according to the fifth storing signal, the processor 130 executes the second update firmware to update the basic input/output system and generates an update completion signal after the update of the basic input/output system is completed. Subsequently, the controller 140 disables the shared space 111 according to the update completion signal.

In this way, for the electronic apparatus 100, the baseboard management controller 120 and the processor 130 may exchange a heavy load of data through the shared space 111, and the controller 140 may determine whether to enable or disable the shared space 111 according to the control signal outputted from the baseboard management controller 120, thereby enhancing the security and the efficiency of data transmission.

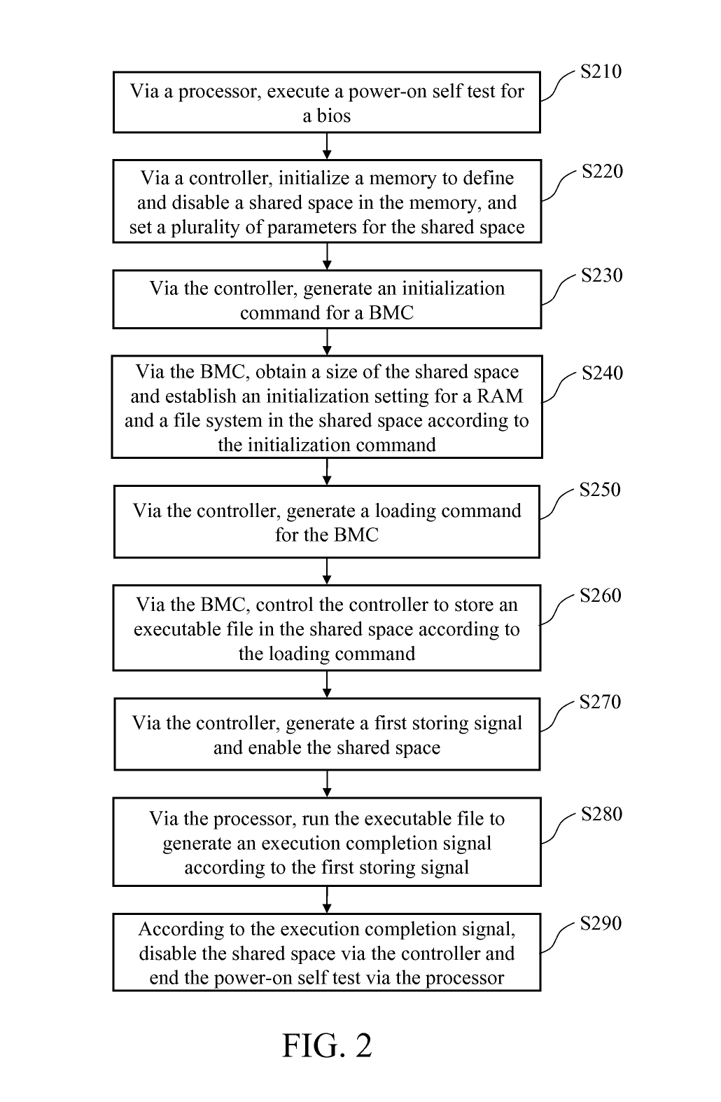

In view of the above embodiments, an operation method of the electronic apparatus can be arranged. Referring to FIG. 2, FIG. 2 is a flow chart of an operation method of an electronic apparatus in the disclosure. The operation method includes the following steps: in step S210, via a processor, execute a power-on self test for a basic input/output system; in step S220, via a controller, initialize a memory to define a shared space in the memory, set a plurality of parameters for the shared space and disable the shared space; in step S230, via the controller, generate an initialization command for a baseboard management controller; in step S240, via the baseboard management controller, obtain a size of the shared space and establish an initialization setting for a random access memory and a file system in the shared space according to the initialization command; in step S250, via the controller, generate a loading command for the baseboard management controller; in step S260, via the baseboard management controller, control the controller to store an executable file in the shared space according to the loading command; in step S270, via the controller, generate a first storing signal and enable the shared space; in step S280, via the processor, run the executable file to generate an execution completion signal according to the first storing signal; and in step S290, according to the execution completion signal, disable the shared space via the controller and end the power-on self test via the processor.

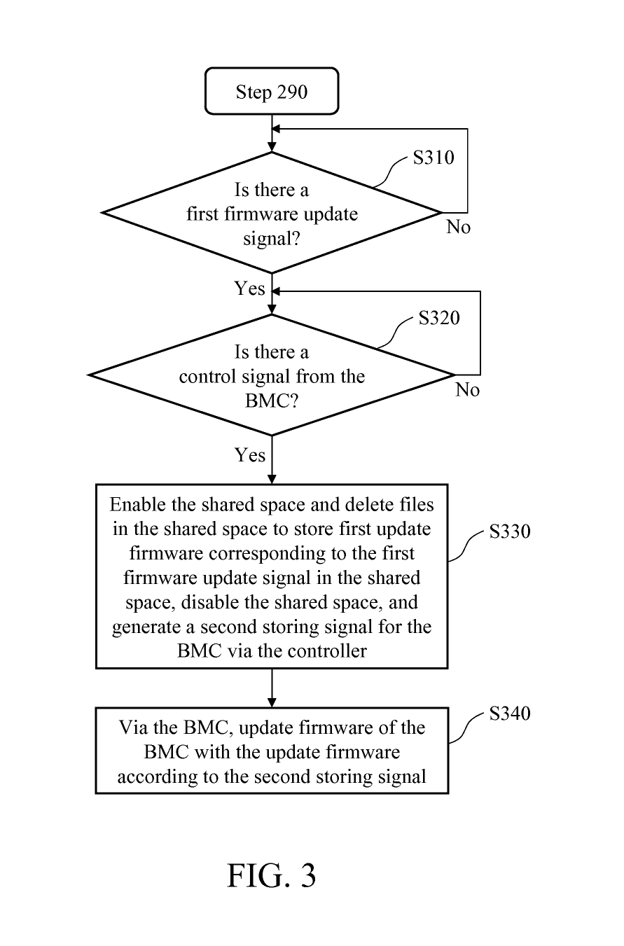

Referring to FIG. 3, FIG. 3 is a flow chart of a first embodiment following the step S290 in FIG. 2. In step S310, the controller determines whether a first firmware update signal is received. When the controller does not receive the first firmware update signal, the step S310 is repeated to continue determining whether the controller receives the first firmware update signal. In contrast, when the controller receives the first firmware update signal, as shown in step S320, of the controller determines whether a control signal is received from the baseboard management controller. When the controller does not receive the control signal, the step S320 is repeated to continue determining whether the control signal is received from the baseboard management controller. When the controller receives the control signal, as shown in step S330, of the controller enables the shared space and deletes files in the shared space to store first update firmware corresponding to the first firmware update signal in the shared space, disables the shared space, and generates a second storing signal for the baseboard management controller. In step S340, the baseboard management controller updates with the update firmware according to the second storing signal.

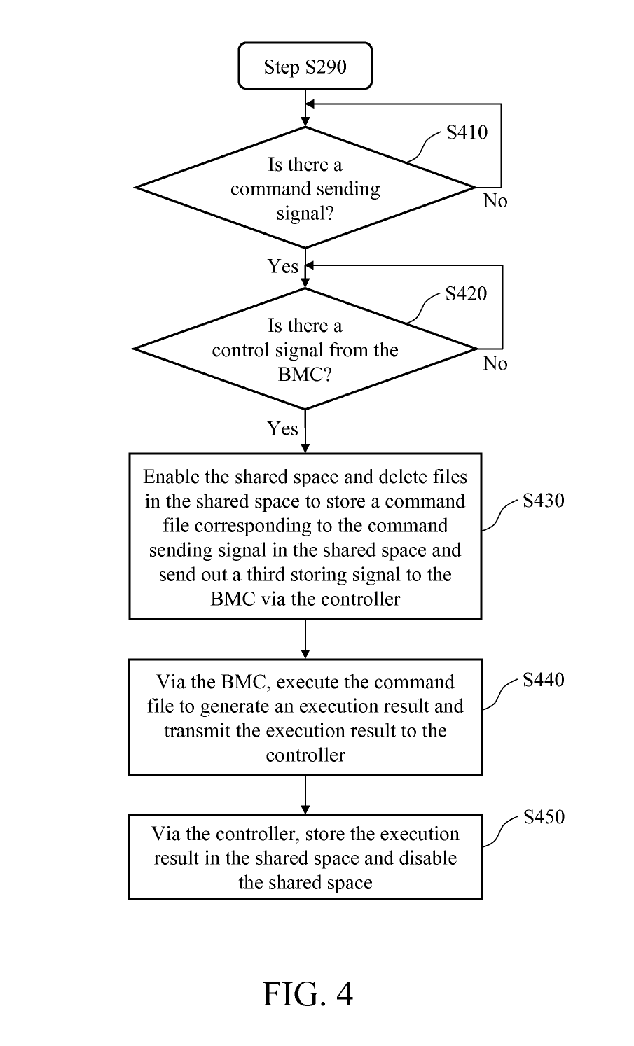

Referring to FIG. 4, FIG. 4 is a flow chart of a second embodiment following the step S290 in FIG. 2. In step S410, the controller determines whether a command sending signal is received. When the controller does not receive the command sending signal, the step S410 is repeated to continue determining whether the command sending signal is received. When the controller receives the command sending signal, as shown in step S420, the controller determines whether a control signal is received from the baseboard management controller.

When the controller does not receive the control signal, the step S420 is repeated to continue determining whether control signal is received from the baseboard management controller. When the controller receives the control signal, as shown in step S430, of the controller enables the shared space, deletes files in the shared space to store a command file corresponding to the command sending signal in the shared space, and sends a third storing signal to the baseboard management controller. In step S440, the baseboard management controller executes the command file to generate an execution result and transmit the execution result to the controller. In step S450, the controller stores the execution result in the shared space and disables the shared space.

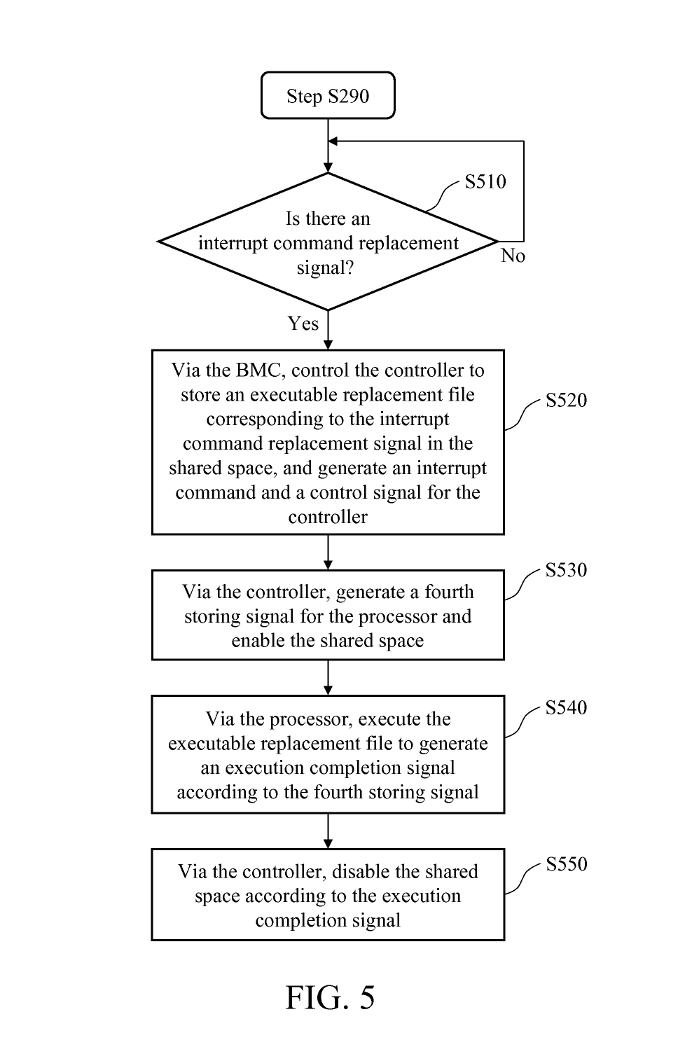

Referring to FIG. 5, FIG. 5 is a flow chart of a third embodiment following the step S290 in FIG. 2. In step S510, the baseboard management controller determines whether an interrupt command replacement signal is received. When the baseboard management controller does not receive the interrupt command replacement signal, the step 510 is repeated to continue determining whether the interrupt command replacement signal is received. In contrast, when the baseboard management controller receives the interrupt command replacement signal, as shown in step S520, the baseboard management controller controls the controller to store an executable replacement file corresponding to the interrupt command replacement signal in the shared space, and generates an interrupt command and a control signal for the controller.

In step S530, the controller generates a fourth storing signal for the processor and enables the shared space. In step S540, the processor executes the executable replacement file to generate an execution completion signal according to the fourth storing signal. In step S550, the controller disables the shared space according to the execution completion signal.

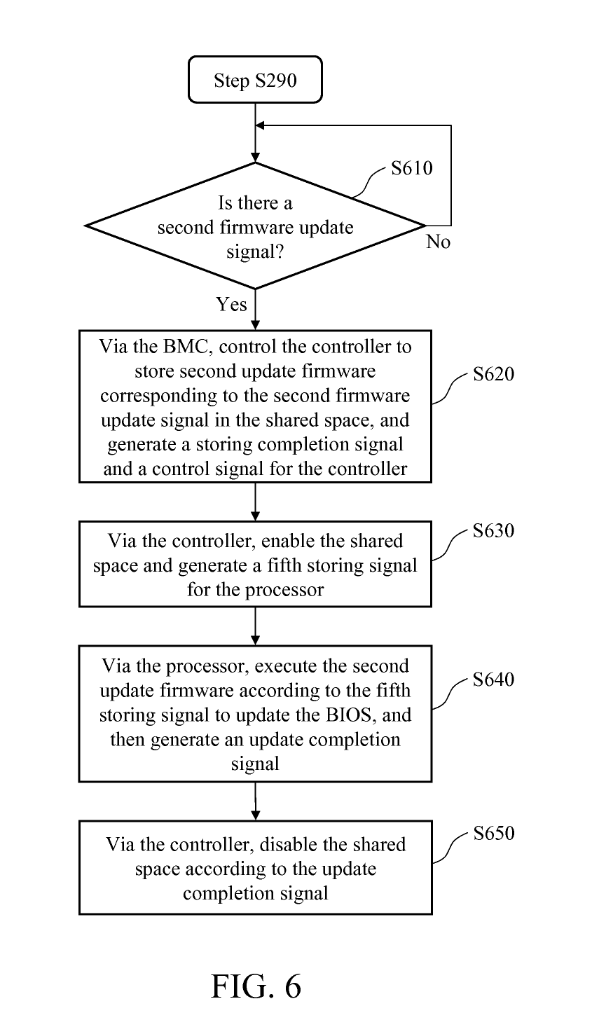

Referring to FIG. 6, FIG. 6 is a flow chart of a fourth embodiment following the step S290 in FIG. 2. In step S610, the baseboard management controller determines whether a second firmware update signal is received. When the baseboard management controller does not receive the second firmware update signal, the step S610 is repeated to continue determining whether the second firmware update signal is received. In contrast, when the baseboard management controller receives the second firmware update signal, as shown in step S620, the baseboard management controller controls the controller to store second update firmware corresponding to the second firmware update signal in the shared space, and generates a storing completion signal and a control signal for the controller. In step S630, the controller enables the shared space and generates a fifth storing signal for the processor. In step S640, the processor executes the second update firmware according to the fifth storing signal to update the basic input/output system and then generates an update completion signal. In step S650, the controller disables the shared space according to the update completion signal.

In summary, the electronic apparatus and the operation method thereof in the disclosure state that with a shared space defined in the memory, the baseboard management controller and the processor can exchange data, such as executable files, update firmware, command files, or executable replacement files, through this shared space. Moreover, the controller may determine whether to enable or disable the shared space, according to the control signal sent from the baseboard management controller. Therefore, the electronic apparatus may exchange a heavy load of data with enhanced security and efficiency.

What is claimed is:

1. An electronic apparatus, comprising:
a memory, comprising a shared space;
a baseboard management controller;
a processor, configured to execute a basic input/output system for a power-on self test; and
a controller, coupled with the memory, the baseboard management controller, and the processor, wherein during the power-on self test, the controller is configured to initialize the memory, set a plurality of parameters for the shared space in the memory, disable the shared space, and generate an initialization command according to which the baseboard management controller obtains a size of the shared space and establishes an initialization setting for a random access memory and a file system in the shared space, is configured to generate a loading command according to which the baseboard management controller stores an executable file in the shared space through the controller, and then is configured to enable the shared space and generate a first storing signal according to which the processor runs the executable file to generate an execution completion signal; and according to the execution completion signal, the controller disables the shared space and the processor ends the power-on self test.

2. The electronic apparatus according to claim 1, wherein when the controller receives a first firmware update signal, the controller enables the shared space and deletes files in the shared space according to a control signal outputted from the baseboard management controller, to store first update firmware corresponding to the first firmware update signal in the shared space, disable the shared space, and generate a second storing signal for the baseboard management controller so that the baseboard management controller updates firmware of the baseboard management controller with the first update firmware according to the second storing signal.

3. The electronic apparatus according to claim 1, wherein when the controller receives a command sending signal, the controller enables the shared space and deletes files in the shared space according to a control signal outputted from the baseboard management controller, to store a command file corresponding to the command sending signal in the shared space, and send out a third storing signal to the baseboard management controller, the baseboard management controller executes the command file according to the third storing signal to generate an execution result, and the controller stores the execution result in the shared space and disables the shared space.

4. The electronic apparatus according to claim 1, wherein when the baseboard management controller receives an interrupt command replacement signal, the baseboard management controller stores an executable replacement file corresponding to the interrupt command replacement signal in the shared space via the controller, and generates an interrupt command and a control signal for the controller so that the controller generates a fourth storing signal for the processor and enables the shared space, the processor then executes the executable replacement file to generate an execution completion signal according to the fourth storing signal, and the controller disables the shared space according to the execution completion signal.

5. The electronic apparatus according to claim 1, wherein when the baseboard management controller receives a second firmware update signal, the baseboard management controller stores second update firmware corresponding to the second firmware update signal in the shared space through the controller, and generates a storing completion signal and a control signal for the controller so that the controller enables the shared space and generates a fifth storing signal for the processor, the processor executes the second update firmware according to the fifth storing signal to update the basic input/output system, and then generates an update completion signal, and the controller disables the shared space according to the update completion signal.

6. An operation method of an electronic apparatus, comprising:
via a processor, executing a power-on self test for a basic input/output system;
via a controller, initializing a memory to define a shared space in the memory, set a plurality of parameters for the shared space and disable the shared space;
via the controller, generating an initialization command for a baseboard management controller;
via the baseboard management controller, obtaining a size of the shared space and establishing an initialization setting for a random access memory and a file system in the shared space according to the initialization command;
via the controller, generating a loading command for the baseboard management controller;
via the baseboard management controller, controlling a controller to store an executable file in the shared space according to the loading command;
via the controller, generating a first storing signal and enabling the shared space;
via the processor, running the executable file to generate an execution completion signal according to the first storing signal; and
according to the execution completion signal, disabling the shared space via the controller and ending the power-on self test via the processor.

7. The operation method according to claim 6, further comprising steps of:
determining whether the controller receives a first firmware update signal;
when the controller does not receive the first firmware update signal, repeating the step of determining whether the controller receives the first firmware update signal;
when the controller receives the first firmware update signal, determining whether the controller receives a control signal from the baseboard management controller;
when the controller receives the control signal, enabling the shared space and deleting files in the shared space to store first update firmware corresponding to the first firmware update signal in the shared space, disable the shared space, and generate a second storing signal for the baseboard management controller via the controller; and
via the baseboard management controller, updating firmware of the baseboard management controller with the first update firmware according to the second storing signal.

8. The operation method according to claim 6, further comprising steps of:
determining whether the controller receives a command sending signal;
when the controller does not receive the command sending signal, repeating the step of determining whether the controller receives the command sending signal;
when the controller receives the command sending signal, determining whether the controller receives a control signal from the baseboard management controller;
when the controller receives the control signal, enabling the shared space and deleting files in the shared space to store a command file corresponding to the command sending signal in the shared space and send out a third storing signal to the baseboard management controller via the controller;
via the baseboard management controller, executing the command file to generate an execution result and transmit the execution result to the controller; and
via the controller, storing the execution result in the shared space and disabling the shared space.

9. The operation method according to claim 6, further comprising steps of:
determining whether the baseboard management controller receives an interrupt command replacement signal;
when the baseboard management controller does not receive the interrupt command replacement signal, repeating the step of determining whether the baseboard management controller receives the interrupt command replacement signal;
when the baseboard management controller receives the interrupt command replacement signal, via the baseboard management controller, controlling the controller to store an executable replacement file corresponding to the interrupt command replacement signal in the shared space, and generating an interrupt command and a control signal for the controller;
via the controller, generating a fourth storing signal for the processor and enabling the shared space;
via the processor, executing the executable replacement file to generate an execution completion signal according to the fourth storing signal; and
via the controller, disabling the shared space according to the execution completion signal.

10. The operation method according to claim 6, further comprising steps of:
determining whether the baseboard management controller receives a second firmware update signal;
when the baseboard management controller does not receive the second firmware update signal, repeating the step of determining whether the baseboard management controller receives the second firmware update signal;
when the baseboard management controller receives the second firmware update signal, via the baseboard management controller, controlling the controller to store a second update firmware corresponding to the second firmware update signal in the shared space, and generating a storing completion signal and a control signal for the controller;
via the controller, enabling the shared space and generating a fifth storing signal for the processor;
via the processor, executing the second update firmware according to the fifth storing signal to update the basic input/output system, and then generating an update completion signal; and
via the controller, disabling the shared space according to the update completion signal.
